(19) United States
(12) Patent Application Publication
(10) Pub. No.: US 2008/0303243 A1
(43) Pub. Date: Dec. 11, 2008

(54) Collapsible bicycle frame

(76) Inventor: Francis Ying, Walnut, CA (US)

Correspondence Address: FRANCIS YING, 20901 NORTHVIEW DR., Walnut, CA, 91789, US

(21) Appl. No.: 11/811,006

(22) Filed: Jun. 8, 2007

(51) Int. Cl. B62K 15/00

(52) U.S. Cl. 280/287

(57) ABSTRACT

Collapsible bicycle frame with an elongate tubular rigid seat post holding member, an elongate tubular rigid front fork holding member and an elongate tubular first rear fork and crank holding member. A slidable clevis joint holding the rear fork holding member to the front fork holding member. A clevis joint holds the seat post holding member to the front fork holding member. A clevis joint holds the lower end of the seat post holding member to a second rear fork member. The first rear fork holding member includes a standard crank holding aperture. The front fork holding member terminates at its top most point in a standard handle bar receiving aperture. The seat post holding member includes a lockable tubular extension member that can slidably retain a standard bicycle seat post.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of bicycles and more specifically to a collapsible bicycle frame.

Bicycles have been helping people transport themselves from one place to another for over one hundred years. Over those years many improvements have been made regarding efficiency and reliability.

More recently, efforts have been made to make bicycles more portable so that they can be put in compact areas such as the trunk of a motor vehicle. To this end, the category of folding bicycles has come into being. Although many folding designs have aided in transporting bicycles within compact areas there is still a deficiency in the current designs

Current folding bicycle frame designs, although more compact than a standard bicycle, still can not be easily carried onto public mass transit such as a bus. Because of this, many people who might take the bus, decide to drive their own motor vehicles instead thereby creating unwanted traffic congestion and air pollution.

### BRIEF SUMMARY OF THE INVENTION

The primary object of the invention is to provide a bicycle frame that folds to enable the user to walk the bicycle outdoors or indoors with minimum effort.

Another object of the invention is to provide a bicycle frame that enables a bicycle to collapse for storage purposes including enabling the user to carry the bicycle onto public transport such as a bus.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed collapsible bicycle frame comprising: an elongate tubular rigid seat post holding member, an elongate tubular rigid front fork holding member, an elongate tubular first rear fork holding member, a clevis joint holding said rear fork holding member to said front fork holding member, a slidable and lockable and sleeve clevis joint holding said seat post holding member to said front fork holding member, a clevis joint holding the lower end of said seat post holding member to a second rear wheel holding fork member, said first rear fork holding member including a standard crank holding aperture, said front fork holding member terminating at its top most point in a standard handle bar retaining aperture, and said seat post holding member including a lockable tubular extension member that can slidably retain a standard bicycle seat post.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the collapsible bicycle frame of the present invention in the unfolded position.

FIG. 2 is a perspective view of the collapsible bicycle frame of the present invention in the folded position.

FIG. 3 is a perspective view of the bicycle frame of the present invention in use and in the unfolded position.

FIG. 4 is a perspective view of the bicycle frame of the present invention in use and in the folded position.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

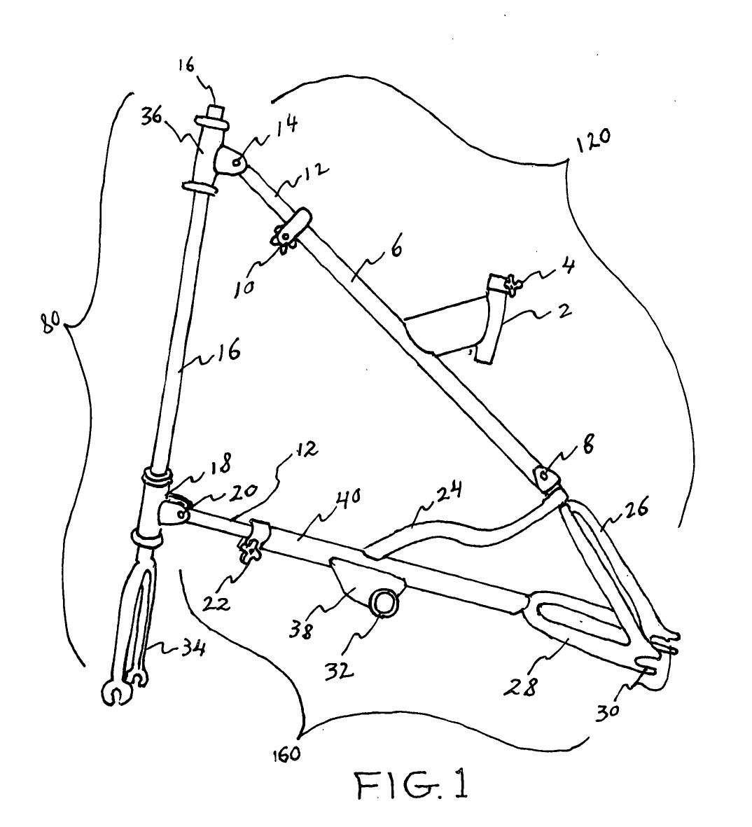

Referring now to FIG. 1 we see a side perspective view of the collapsible bicycle frame of the present invention. The frame includes a front fork assembly 80, a diagonal brace assembly 120 and a rear fork and crank brace assembly 160. The front fork assembly 180 includes a handle bar support tube 36, a front fork tube 16, a front fork 34 and fork support tube 18. Fork 34 and tube 16 are fixedly joined to each other in a standard way. Front fork tube 16 can swivel within support tube 36 and support tube 18 in a standard way. Diagonal brace assembly 120 is comprised of a main brace tube 6 and an extendable brace tube 12. Tube 12 can be locked in place by compression joint 10. A standard bike seat support assembly 2 including locking compression joint 4 is welded to diagonal post 6 as shown. Diagonal brace tube 6 and telescoping tube 12 terminate at its upper end in a pinned rotatable joint formed with clevis 14 which is welded to the side of handle bar support tube 36. Diagonal brace tube 6 terminates at its lower end in a pinned rotatable joint formed with clevis 8 which is welded to one end of S tube 24. Crank brace assembly 160 is comprised of a main brace tube 40 and an extension tube 12. Standard locking joint 22 causes telescoping tube 12 to be locked in place with respect to main brace tube 40. A crank casing tube 32 is welded to tube 40 via bracket 38. One end of an S shaped tube 24 is welded to tube 40 just above crank casing tube 32. The opposite end of S shaped tube 24 is welded to a secondary rear fork 26 and clevis 8. Crank brace and rear fork assembly 160 is completed by primary rear fork 28. The primary rear fork 28 and the secondary rear fork 26 are welded together to form rear wheel joint 30. Telescoping tube 12 is rotatably pinned to front fork tube 18 by clevis 20 which is welded to tube 18.

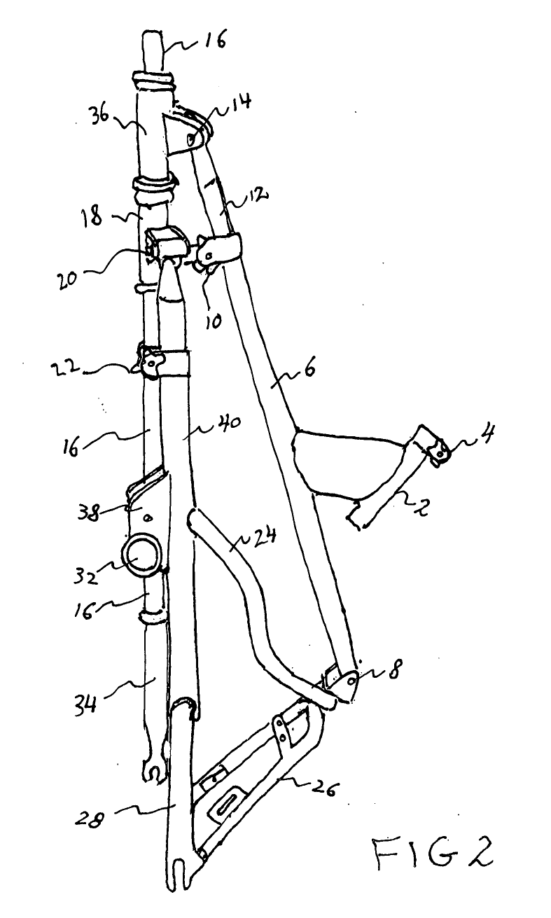

FIG. 2 shows the collapsible bike frame of the present invention in its folded position. This compact format is made possible because front fork support tube 18 has been slid up front fork tube 16 so that is in close proximity with support handle bar tube 36. Additionally, Telescoping tube 12 can also be adjusted in length with respect to diagonal brace tube 6 to further accommodate the frame collapsing process. Adjustment of telescoping tube 12 also helps adjust the overall dimensions of the bike so that it can accommodate riders with shorter arms and torsos or longer arms and torsos. Clevis joints 8, 14, and 20 all act in concert with each other to allow for the collapsing process to take place.

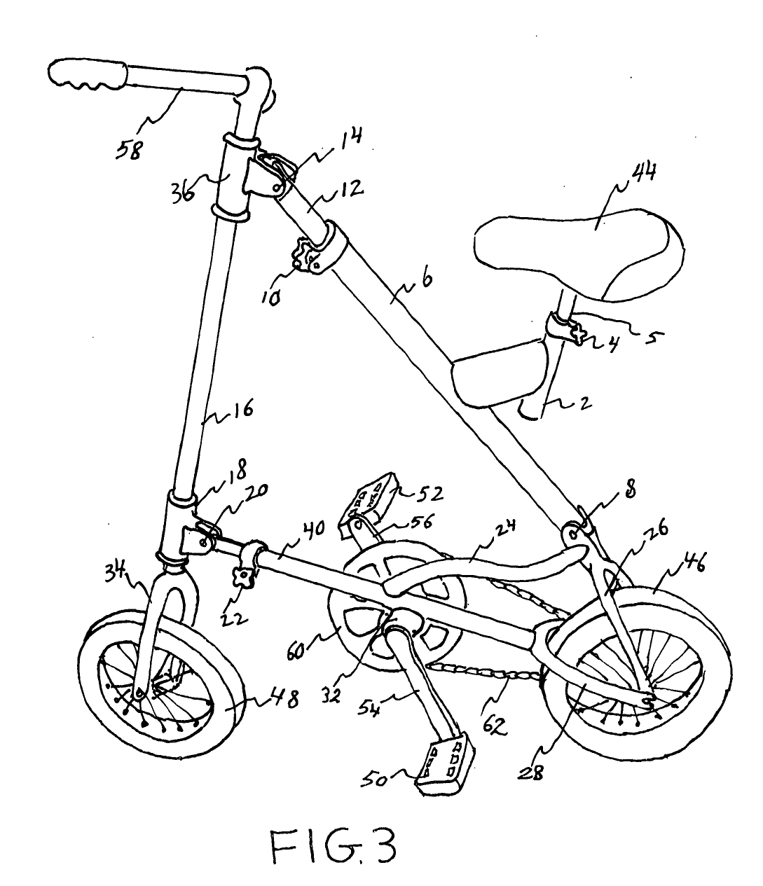

FIG. 3 shows a perspective view of the collapsible bike frame of the present invention in use along with the addition of standard bicycle parts. Crank arms 54, 56 rotate within crank casing 32 in a standard way. Pedals 50, 52 are attached to the crank arms 54, 56 in a standard way. Gear toothed hub 60 and drive chain 62 are attached in a standard way. Front wheel 48 is attached to front fork 34 in a standard way. Rear wheel 46 is attached to primary 26 and secondary 28 rear forks in a standard way. Seat tube 5 and seat 44 are attached to seat tube retainer tube 2 in a standard way and locked in place by locking joint 4 in a standard way. Handle bar 58 is attached to front fork tube 16 in a standard way.

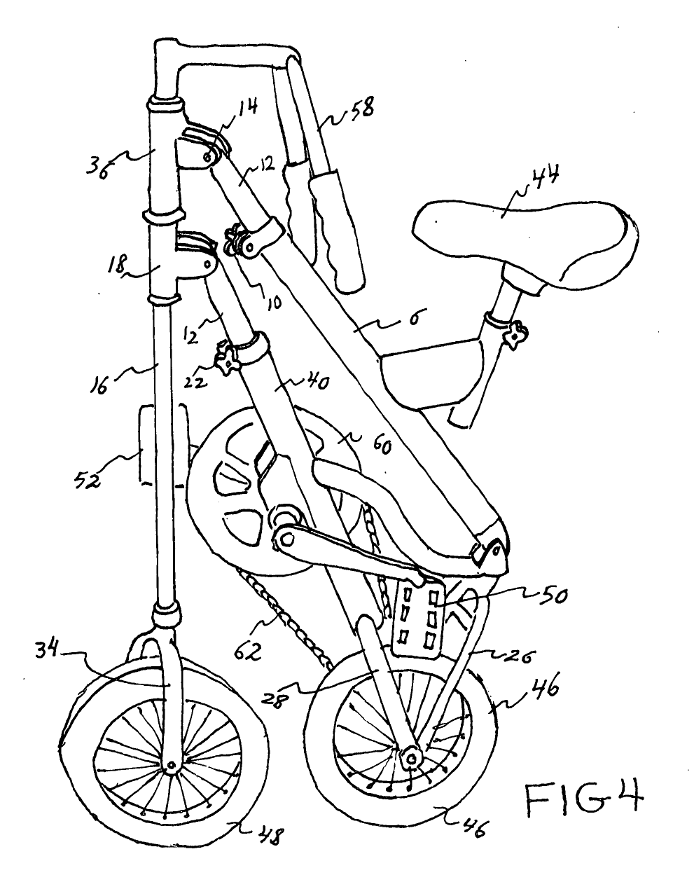

FIG. 4 shows a view of the collapsible bicycle frame of the present invention in use with standard bike parts and in its folded position. The frame has been collapsed as shown and described in FIG. 2. Pedals 50, and 52 are folded down for increased compactness. This folded configuration is so compact and small that the entire bicycle can be carried onto mass transit such as a bus. The user can ride his or her bicycle to a bus stop, fold the bike to its most compact form, carry the folded bicycle onto the bus, and then exit the bus, unfold the bike and ride the rest of the way to home, office or other nearby location. FIG. 4 also show that a person can easily walk and roll the folded bicycle on its two wheels without the need to physically lift and carry the bicycle.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. collapsible bicycle frame comprising:
an elongate tubular telescoping seat post and second rear fork holding assembly;
an elongate tubular rigid front fork holding assembly;
an elongate tubular telescoping first rear fork and crank holding assembly;
said telescoping assemblies including a standard adjustable length locking means;
said front fork assembly including upper and lower clevis joints;
said upper front fork clevis rotatably holding one end of said diagonal seat post holding member and said lower clevis joint holding one end of said rear fork and crank tube member;
said lower front fork clevis joint sleeve being slidable and lockable along the length of said front fork tube;
said first rear fork holding member including a standard crank holding aperture;
said front fork holding member terminating at its top most portion in a standard handle bar post receiving aperture; and
said seat post holding member including a lockable tubular member that can slidably retain a standard bicycle seat post.
